(19) United States
(12) Patent Application Publication
(10) Pub. No.: US 2018/0194958 A1
(43) Pub. Date: Jul. 12, 2018

(54) INK COMPOSITIONS

(71) Applicant: Hewlett-Packard Development Company, L.P., Fort Collins, CO (US)

(72) Inventors: Jayprakash C. Bhatt, Corvallis, OR (US); Palitha Wickramanayake, Corvallis, OR (US)

(73) Assignee: Hewlett-Packard Development Company, L.P., Fort Collins, CO (US)

(21) Appl. No.: 15/742,209

(22) PCT Filed: Oct. 14, 2015
(86) PCT No.: PCT/US2015/055453

§ 371 Date: Jan. 5, 2018

(51) Int. Cl. C09D 11/40; C09D 11/037; C09D 11/107; C09D 11/322

(52) U.S. Cl. CPC C09D 11/40; C09D 11/322; C09D 11/107; C09D 11/037

(57) ABSTRACT

The present disclosure is drawn to ink compositions comprising from 1 wt % to 8 wt % of a colored pigment and a polymeric dispersant. The polymeric dispersant can be associated with the pigment and the weight ratio of the polymeric dispersant to pigment can be less than 0.33. The polymeric dispersant can have hydrophilic moieties and hydrophobic moieties and an acid number from about 40 to about 180. The ink composition can have an effective charge stabilization from about 0.3 to about 1.8 that is calculated based on a product of the acid number of the polymeric dispersant, the polymer dispersant to pigment weight ratio, and the pigment load in the ink.

### BACKGROUND

Color pigments are typically dispersed or suspended in a liquid vehicle to be utilized in inks. A variety of colored pigments are difficult to disperse and stabilize in water-based vehicles due to the nature of the surface of pigments and the self-assembling behavior of pigments. One way to facilitate color pigment dispersion and sustained suspension in a liquid vehicle is to adding a dispersant, such as a polymer, to the liquid vehicle. The polymer stabilizes the dispersion and/or suspension of the pigments. Often, aqueous pigments based inks that are stabilized using polymer can penetrate print media resulting in low color saturation. Thus, enhancing color saturation of polymer dispersed pigments would be a desirable property to achieve generally.

### BRIEF DESCRIPTION OF THE DRAWINGS

Additional features and advantages of the disclosure will be apparent from the detailed description which follows, taken in conjunction with the accompanying drawings, which together illustrate, by way of example, features of the present technology. It should be understood that the figures are representative examples of the present technology and should not be considered as limiting the scope of the technology.

FIG. 1 is a plot of color saturation vs. effective charge stabilization for the various ink compositions on Hammermill® Great White 30% Recycled Media in accordance with the examples of the present disclosure;

FIG. 2 is a plot of color saturation vs. effective charge stabilization for the various ink compositions on Hammermill® Great White 30% Recycled Media in accordance with the examples of the present disclosure;

FIG. 3 is a plot of color saturation vs. effective charge stabilization for the various ink compositions on Hammermill® Great White 30% Recycled Media in accordance with the examples of the present disclosure;

FIG. 4 is a plot of color saturation vs. effective charge stabilization for the various ink compositions on Hammermill® Great White 30% Recycled Media in accordance with the examples of the present disclosure;

FIG. 5 is a plot of color saturation vs. effective charge stabilization for the various ink compositions on Staples® Copy Paper Media in accordance with the examples of the present disclosure;

FIG. 6 is a plot of color saturation vs. effective charge stabilization for the various ink compositions on Staples® Copy Paper Media in accordance with the examples of the present disclosure;

FIG. 7 is a plot of color saturation vs. effective charge stabilization for the various ink compositions on Staples® Copy Paper Media in accordance with the examples of the present disclosure;

FIG. 8 is a plot of color saturation vs. effective charge stabilization for the various ink compositions on Staples® Copy Paper Media in accordance with the examples of the present disclosure;

FIG. 9 is a bar graph of color saturation for control inks that have a high effective charge stabilization (values >2.40) vs. color saturation for inks having a low effective charge stabilization (values ≤2.40) as printed on Hammermill® Great White 30% Recycled Media; and

FIG. 10 is a bar graph of color saturation for control inks that have a high effective charge stabilization (values >2.40) vs. color saturation for inks having a low effective charge stabilization (values ≤2.40) as printed on Staples® Copy Paper Media.

### DETAILED DESCRIPTION

The present disclosure is drawn to ink compositions, ink sets, and methods of making ink compositions. The ink compositions, ink sets, and methods described herein include pigments remain dispersed or suspended in a liquid vehicle and exhibit enhanced color saturation when printed on media. In accordance with the present disclosure, a polymeric dispersant can be used to disperse or suspend color pigments that would otherwise clump together and settle out of the liquid vehicle. Polymers disperse the pigment by being absorbed or attracted to the surface of the pigment particles. The two principal mechanisms of stabilization are steric stabilization and electrostatic stabilization. Steric stabilization occurs when the outer surface of a colored pigment becomes completely surrounded by polymer; thereby preventing individual pigments from clumping together. Electrostatic stabilization occurs when the outer surface of the pigments becomes essentially equally charged. The equal charge on the outer surface of individual colored pigments results in a Coulomb-repulsion that prevents individual colored pigments from clumping together. The ink compositions and methods described herein provide for control of electrostatic stabilization of ink compositions, thereby allowing for the control of color saturation of the ink compositions when printed on print media.

In accordance with this, one example the present technology is drawn to an ink composition comprising from 1 wt % to 8 wt % of a colored pigment and a polymeric dispersant. The polymeric dispersant can be associated with the pigment and the weight ratio of the polymeric dispersant to pigment can be less than 0.33. The polymeric dispersant can have hydrophilic moieties and hydrophobic moieties and an acid number from about 40 to about 180. The ink composition can have an effective charge stabilization from about 0.3 to about 1.8 that is calculated based on a product of the acid number of the polymeric dispersant, the polymer dispersant to pigment weight ratio, and the pigment load in the ink.

In another example, a method of making an ink composition is provided. The method comprises dispersing a pigment with a polymeric dispersant. The weight ratio of the polymeric dispersant to pigment can be less than 0.33. The polymeric dispersant can have hydrophilic moieties and hydrophobic moieties and an acid number from about 40 to about 180. The method can further include admixing a liquid vehicle with the pigment and polymer dispersant to form an ink composition having a pigment load from 1 wt % to 8 wt %. The ink composition can have an effective charge stabilization from about 0.3 to about 1.8 that is calculated based on a product of the acid number of the polymeric dispersant, the polymer dispersant to pigment weight ratio, and the pigment load in the ink composition.

In yet another example, an ink set is provided. The ink set can comprise a cyan ink, a magenta ink, and a yellow ink. The cyan ink can have from 1 wt % to 8 wt % cyan pigment load and a polymer dispersant associated with the pigment. The polymeric dispersant can have hydrophilic moieties and hydrophobic moieties, and an acid number from about 40 to about 180. The weight ratio of the polymeric dispersant to the pigment is less than 0.25. The effective charge stabilization can be from about 0.6 to about 1.5 and is calculated based on a product of the acid number of the polymer dispersant, the polymer dispersant to pigment weight ratio, and the cyan pigment load in the cyan ink composition. The magenta ink can have from 1 wt % to 8 wt % magenta pigment load and a polymeric dispersant associated with the pigment. The polymeric dispersant can have hydrophilic moieties and hydrophobic moieties, and an acid number of less than 150. The weight ratio of the polymeric dispersant to the pigment is less than 0.25. The effective charge stabilization can be from about 0.3 to 1.2 and is calculated based on a product of the acid number of the polymer dispersant, the polymer dispersant to pigment weight ratio, and the magenta pigment load in the magenta ink composition. The yellow ink can have from 1 wt % to 8 wt % yellow pigment load and a polymer dispersant associated with the pigment. The polymeric dispersant can have hydrophilic moieties and hydrophobic moieties and an acid number from about 40 to about 180. The weight ratio of the polymer dispersant to pigment is less than 0.25. The effective charge stabilization can be from about 0.5 to 1 and is calculated based on a product of the acid number of the polymer dispersant, the polymer dispersant to pigment weight ratio, and the yellow pigment load in the yellow ink composition.

The ink compositions and ink sets disclosed herein exhibit enhanced color saturation on print media. A relationship exists between the effective charge stabilization value of the ink composition and the color saturation of the ink when printed on media. Ink compositions with low values for the effective charge stabilization (values ≤1.8) exhibit more color saturation than similar ink compositions that have high values of effective charge stabilization (values >1.8). The effective charge stabilization of ink compositions depends upon the number of acid groups present on the polymeric dispersant, the weight ratio of the polymeric dispersant to the pigment in the pigment dispersion, and the pigment load in the ink composition. Effective Charge Stabilization can be calculated using Formula I below.

(Polymeric Dispersant Acid Number)×(Weight Ratio of the Polymeric Dispersant to Pigment)×(Total Pigment Load)=Effective Charge Stabilization Formula I

The Effective Charge Stabilization value of an ink composition can be adjusted by lowering one or more of: the acid groups present on the polymeric dispersant, the weight ratio of the polymeric dispersant to the pigment in the pigment dispersion, and/or the total pigment load in the ink composition. As a note, when comparing inks with different effective charge stabilization, the pigment load should be the same so effective charge stabilization can be compared to one another on a relative basis. The effective charge stabilization values for the ink compositions and ink sets disclosed herein can range from about 0.3 to about 2.4, but desirable color saturation occurs typically within the range of about 0.3 to 1.8. The bottom value for the range provides, in many cases, a high enough value to assist the pigment in remain dispersed or suspended in the ink composition, while the upper limit provides a low enough value to retain good color saturation, e.g., the effective charge stabilization is low enough to receive the added benefit of enhanced color saturation on a printed media. Exemplary effective charge stabilization ranges that can be used to further enhance color saturation in some cases can be from about 0.3 to about 1.5, from about 0.6 to about 1.5, from about 0.3 to about 1.2, from about 0.5 to about 1, or from about 0.5 to about 0.8, for example.

With specific reference to the pigment, the pigment is not particularly limited. The particular pigment used will depend on the colorists desires in creating the composition. Pigment colorants can include cyan, magenta, yellow, black, red, blue, orange, green, pink, etc. Suitable organic pigments include, for example, azo pigments including diazo pigments and monoazo pigments, polycyclic pigments (e.g., phthalocyanine pigments such as phthalocyanine blues and phthalocyanine greens, perylene pigments, perynone pigments, anthraquinone pigments, quinacridone pigments, dioxazine pigments, thioindigo pigments, isoindolinone pigments, pyranthrone pigments, and quinophthalone pigments), nitropigments, nitroso pigments, anthanthrone pigments such as PR168, and the like. Representative examples of phthalocyanine blues and greens include copper phthalocyanine blue, copper phthalocyanine green and derivatives thereof such as Pigment Blue 15, Pigment Blue 15:3, and Pigment Green 36. Representative examples of quinacridones include Pigment Orange 48, Pigment Orange 49, Pigment Red 122, Pigment Red 192, Pigment Red 202, Pigment Red 206, Pigment Red 209, Pigment Violet 19, and Pigment Violet 42. Representative examples of anthraquinones include Pigment Red 43, Pigment Red 194, Pigment Red 177, Pigment Red 216, and Pigment Red 226. Representative examples of perylenes include Pigment Red 123, Pigment Red 190, Pigment Red 189, and Pigment Red 224. Representative examples of thioindigoids include Pigment Red 86, Pigment Red 87, Pigment Red 198, Pigment Violet 36, and Pigment Violet 38. Representative examples of heterocyclic yellows include Pigment Yellow 1, Pigment Yellow 12, Pigment Yellow 13, Pigment Yellow 14, Pigment Yellow 17, Pigment Yellow 73, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Other pigments that can be used include Pigment Blue 15:3, DIC-QA Magenta Pigment, Pigment Red 150, and Pigment Yellow 74. Such pigments are commercially available in powder, press cake, or dispersions form from a number of sources.

If the colorist desires, two or more pigments can be combined to create novel color compositions, but the polymer dispersant to pigment weight ratio and the total pigment load is to be considered based on the entire pigment load (cumulative based on all pigments). In one example, a pigment combination can form a red ink by combining a magenta pigment and a yellow pigment, e.g. 50-60 wt % magenta pigment and 40-50 wt % yellow pigment. In another example, the pigment combination can form a green ink by combining a yellow pigment and a cyan pigment, e.g., 65-75 wt % yellow pigment and 25-35 wt % cyan pigment. In yet another example, the pigment combination can form a blue ink by combining cyan pigment and magenta pigment, e.g., 85-95 wt % cyan pigment and 5-15 wt % magenta pigment.

The pigments of the present disclosure can be from nanometers to a micron in size, e.g., 20 nm to 1 μm. In one example the pigment can be from about 50 nm to about 500 nm in size. Pigment sizes outside this range can be used if the pigment can remain dispersed and provide adequate printing properties.

The pigment load in the ink compositions can range from 1 wt % to 8 wt %. In one example, the pigment load can be from 2 wt % to 7 wt %. In a further example, the pigment load can be from 2 wt % to 6 wt %. The pigment load is generally less than 8 wt % in ink compositions described herein.

With specific reference to the polymer in each of these examples, the polymeric dispersant used can be any suitable polymeric dispersant known in the art that is sufficient to form an attraction with the pigment particles, contains acid groups, and comprises both hydrophilic moieties and hydrophobic moieties. The ratio of hydrophilic moieties to the hydrophobic moieties can range widely, but in certain specific examples, the weight ratios can be from about 1:5 to about 5:1. In another example, the ratio of hydrophilic moieties to the hydrophobic moieties can range from about 1:3 to about 3:1. In yet another example, the ratio of hydrophilic moieties to the hydrophobic moieties can range from about 1:2 to about 2:1. In one example, the polymeric dispersant can include a hydrophilic end and a hydrophobic end. The polymer can be a random copolymer or a block copolymer.

The particular polymeric dispersant can vary based on the pigment; however, the hydrophilic moieties typically comprise acid groups. Some suitable acid monomers for the polymeric dispersant comprise acrylic acid, methacrylic acid, carboxylic acid, sulfonic acid, phosphonic acid, and combinations of these monomers. The hydrophobic monomers can be any hydrophobic monomer that is suitable for use, but in one example, the hydrophobic monomer can be styrene. Other suitable hydrophobic monomers can include isocyanate monomers, aliphatic alcohols, aromatic alcohols, diols, polyols, or the like, for example. In one specific example, the polymeric dispersant comprises polymerized monomers of styrene and acrylic acid at a 5:1 to 1:5 weight ratio.

The weight average molecular weight (Mw) of the polymeric dispersant can vary to some degree, but in one example, the weight average molecular weight of the polymeric dispersant can range from about 5,000 Mw to about 20,000 Mw. In another example, the weight average molecular weight can range from about 7,000 Mw to about 12,000 Mw. In another example, the weight average molecular weight ranges from about 5,000 Mw to about 15,000 Mw. In yet another example, the weight average molecular weight ranges from about 8,000 Mw to about 10,000 Mw.

The acid number of the polymeric dispersant is typically based on the acid groups that are present on the hydrophilic end of the polymeric dispersant. Determining the acid number or acid value is based on the mass of potassium hydroxide (KOH) in milligrams that is used to neutralize one gram of chemical substance. The acid number of the polymeric dispersant can be varied in order to control the effective charge stabilization of the ink composition. The acid number of the polymer can be, for example, from about 40 to about 180. In another example the acid number ranges from about 100 to about 180, or from about 40 to about 150. In yet another example, the acid number can range from about 75 to about 125. These acid values tend to be strong enough to suspend a reasonably high pigment load, while at the same time, are low enough to assist in maintaining a relative low effective charge stabilization value.

The ratio of the polymeric dispersant to pigment in the pigment dispersion can also vary in order to control the effective charge stabilization of the ink composition. Generally the ratio of the polymeric dispersant to pigment is less than about 0.33. In one example the ratio is less than about 0.25. In yet another example, the ratio is equal to or less than about 0.2. In a further example, the ratio less than about 0.15. Again, by keeping this value relatively low, effective charge stabilization can be kept low, even if the acid number is higher or the pigment load is higher in the ink. Again, the present disclosure provides inks with enhanced saturation which is achieved by keeping the effective charge stabilization low. Retaining lower polymeric dispersant to pigment weight ratios may allow for additional flexibility in other areas.

In order to formulate the pigment dispersion into an ink composition, the pigment dispersion is combined with a liquid vehicle. The liquid vehicle is not particularly limited. The liquid vehicle can comprise additional polymers, solvents, surfactants, antibacterial agents, UV filters, and/or other additives. However, as part of the ink composition, the pigment is included. As with the other parameters used to determine effective charge stabilization, a lower pigment load may provide for the ability to be more flexible with other parameters, e.g., acid number of pigment dispersion and polymer dispersant to pigment weight ratio. In other words, the pigment load also has an impact on keeping the effective charge stabilization low (or between a desired range), e.g., ranging from about 0.3 to 1.8, from about 0.3 to about 1.5, from about 0.6 to about 1.5, from about 0.3 to about 1.2, from about 0.5 to about 1, or from about 0.5 to about 0.8, for example. Example pigment ranges have been described previously.

Returning now to the liquid vehicle, solvent of the liquid vehicle can be any solvent or combination of solvents that is compatible with the components of the pigment and polymeric dispersant. Water is typically one of the solvents, and usually, there is one or more organic co-solvent. If an organic co-solvent is added to prepare the pigment dispersion, that co-solvent can be considered when formulating the subsequent ink composition. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, N-methylpyrrolidone (NMP), dimethyl sulfoxide, sulfolane, glycol ethers, alkyldiols such as 1,2-hexanediol, and/or ethoxylated glycerols such as LEG-1, etc. The co-solvent can be present in the ink composition from 5 wt % to about 75 wt % of the total ink composition. In one example, the solvent can be present in the ink composition at about 10 wt % to about 50 wt %, or from about 15 wt % to 35 wt %.

Again, water is typically included and can be added in the ink composition and may provide a large portion of the liquid vehicle (sometimes predominantly water, e.g., greater than 50 wt %). In some examples, water may be present in an amount representing from about 20 wt % to about 90 wt %, or may be present in an amount representing from about 30 wt % to about 80 wt % of the total ink composition.

The liquid vehicle can also include surfactants. In general the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, fluorosurfactants and alcohol ethoxylated surfactants can be used as surfactants. In one example, the surfactant can be Tergitol™ TMN-6, which is available from Dow Chemical Corporation. The surfactant or combinations of surfactants, if present, can be included in the ink composition at from about 0.001 wt % to about 10 wt % and, in some examples, can be present at from about 0.001 wt % to about 5 wt % of the ink compositions. In other examples the surfactant or combinations of surfactants can be present at from about 0.01 wt % to about 3 wt % of the ink compositions.

Consistent with the formulations of this disclosure, various other additives may be employed to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide® (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

Some examples of the ink compositions presented herein include cyan, magenta, and yellow inks. In one example, the pigment in the ink composition is cyan and the effective charge stabilization of the ink composition is from about 0.6 to about 1.5. In another example, the pigment in the ink composition is magenta and the effective charge stabilization of the ink is from about 0.3 to about 1.2. In yet a further example, the pigment in the ink composition is yellow and the effective charge stabilization of the ink is from about 0.5 to about 1.

The ink compositions described above are particularly suited to provide good color saturation on non-specialized print media (even uncoated paper) but can be suitable for use on any type of substrate of print media. The reason these inks are particularly useful with plain paper is that color saturation is diminished fairly significantly as colorant is soaked into the media substrate. This problem is enhanced when the effective charge stabilization is too high. Pigment formulators tend to stabilize inks with high charges, but as discussed herein, such high charge stabilization may not be the best choice for plain paper when trying to enhance saturation.

Suitable examples of media substrates that can be used include, but are not limited to include, cellulose based paper, fiber based paper, inkjet paper, nonporous media, standard office paper, swellable media, microporous media, photobase media, offset media, coated media, uncoated media, plastics, vinyl, fabrics, and woven substrate. That being described, notably, these inks work surprisingly well on plain paper substrates as described herein.

To illustrate, the ink compositions in particular provide about a 5% to 20% increase in color saturation when printed on non-specialized or plain print media. In one example, the increase in color saturation can be about 8% (compared to an identically prepared ink with the same pigment load, but with a polymer dispersant prepared to provide a charge stabilization of about 2.4). In another example, the increase in color saturation can be about 12%. In yet another example, the increase in color saturation can be about 15%.

It is noted herein that the ink compositions, methods, and ink sets are described in some detail with examples related to cyan, magenta, and yellow. However, it is noted that other inks can be prepared using the pigment dispersions described herein, e.g., red ink, a green ink, a blue ink, etc. For example, a red ink can have from 1 wt % to 8 wt % of a mixture of a magenta pigment and a yellow pigment and a polymer dispersant associated with the pigment. The polymeric dispersant can have hydrophilic moieties and hydrophobic moieties, and an acid number from about 40 to about 180. The weight ratio of the polymeric dispersant to the pigment is less than 0.25. The effective charge stabilization can be from about 0.3 to about 1.8 and is calculated based on a product of the acid number of the polymer dispersant, the polymer dispersant to pigment weight ratio, and the pigment load in the ink composition. In one specific example the red pigment in the ink composition can be a mixture of about 50 wt % to 60 wt % magenta pigment and 40 wt % to 50 wt % yellow pigment.

A green ink can have from 1 wt % to 8 wt % of a mixture of a cyan pigment and a yellow pigment and a polymeric dispersant associated with the pigment. The polymeric dispersant can have hydrophilic moieties and hydrophobic moieties, and an acid number from about 40 to about 180. The weight ratio of the polymeric dispersant to the pigment is less than 0.25. The effective charge stabilization can be from about 0.3 to 1.8 and is calculated based on a product of the acid number of the polymer dispersant, the polymer dispersant to pigment weight ratio, and the pigment load in the ink composition. In one specific example the pigment load can be a mixture of 65 wt % to 75 wt % yellow pigment and 25 wt % % to 35 wt % cyan pigment.

A blue ink can have from 1 wt % to 8 wt % of a mixture of a cyan pigment and a magenta pigment and a polymer dispersant associated with the pigment. The polymeric dispersant can have hydrophilic moieties and hydrophobic moieties and an acid number from about 40 to about 180. The weight ratio of the polymer dispersant to pigment is less than 0.25. The effective charge stabilization can be from about 0.3 to 1.8 and is calculated based on a product of the acid number of the polymer dispersant, the polymer dispersant to pigment weight ratio, and the pigment load in the ink composition. In one specific example the pigment load can be a mixture of 80 wt % to 95 wt % cyan pigment and 5 wt % to 20 wt % magenta pigment.

It is noted that, as used in this specification and the appended claims, the singular forms “a,” “an,” and “the” include plural referents unless the content clearly dictates otherwise.

“Effective charge stabilization” refers to the effective electrostatic stabilization value of an ink composition. The effective electrostatic charge stabilization is equal to the polymeric dispersant acid number times the weight ratio of the polymeric dispersant to pigment times the total pigment load in the ink composition. See Formula I herein.

“Relative charge stabilization” refers to the charge stabilization provided by the polymer dispersant acid number times the polymeric dispersant to pigment weight ratio. Relative charge stabilization does not take into account pigment load in the ink composition. Thus, the relative charge stabilization times the pigment load provides the effective charge stabilization values discussed primarily herein.

As used herein “liquid vehicle” refers to a medium in which the pigment and polymeric dispersant are admixed in to form an ink composition. The liquid vehicle can comprise several components including but not limited to solvents, surfactants, biocides, UN filters, preservatives, and other additives.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

When referring to an increase or improvement in performance, the increase or improvement is based on printing using Hammermill® Great White 30% Recycled Media as the print medium which was available at the time of filing of the disclosure in the United States Patent and Trademark Office.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be the acceptable examples.

### Example 1—Preparation of Pigment Dispersions & Ink Compositions

Several different pigments were obtained and various polymeric dispersants were obtained or generated. The pigment dispersions were formulated by dispersing a pigment using a polymeric dispersant comprising styrene and acrylic acid monomers at various and molecular weights to obtain the acid numbers found in Table 1A. The pigment dispersion details used to obtain the effective charge stabilization values are provided in Table 1A, as follows:

TABLE 1A
Pigment Dispersions

| | | | Pigment Dispersion | | |
|---|---|---|---|---|---|
| | | | Polymeric | Weight | |
| | | | Dispersant | Ratio of | |
| | | | Acid Number | Polymeric | Relative |
| | Pigment | Pigment | as measured | Dispersant | Charge |
| Ink ID | Name | ID | by KOH(A) | to Pigment | Stabilization |
| C1 | PB15:3 | Cyan A | 180 | 0.3 | 54 |
| C2 | PB15:3 | Cyan A | 120 | 0.2 | 24 |
| M1 | *DIC-QA | Magenta A | 171 | 0.2 | 34 |
| M2 | *DIC-QA | Magenta A | 117 | 0.2 | 23 |
| M3 | *DIC-QA | Magenta A | 117 | 0.1 | 12 |
| M4 | PR150 | Magenta B | 173 | 0.2 | 35 |
| M5 | PR150 | Magenta B | 117 | 0.1 | 12 |
| Y1 | PY74 | Yellow A | 180 | 0.3 | 54 |
| Y2 | PY74 | Yellow A | 180 | 0.1 | 18 |
| Y3 | PY74 | Yellow A | 117 | 0.1 | 12 |

*Quinacridone type magenta pigment from DIC.

The pigment dispersions of Table 1A were admixed with a liquid vehicle to form various ink compositions. The components of the liquid vehicle were constant in all of the ink compositions. The only difference in each composition was the pigment dispersion. The liquid vehicle components are set forth in Table 1B, as follows.

TABLE 1B
Liquid Vehicle Components

| Ingredient | Class | Weight % |
|---|---|---|
| 2-Pyrrolidinone | Solvent | 9 |
| 2-ethyl-2-(hydroxymethyl)-1, | Solvent | 10 |
| 3-propane diol (EHPD) | | |
| Glycerol | Solvent | 4 |
| LEG-1 | Solvent | 0.75 |
| Tergitol ™ TMN-6* | Surfactant | 0.6 |
| Acticide ® B20* | Biocide | 0.16 |
| Acticide ® M20* | Biocide | 0.07 |
| Color Pigment Dispersion | Pigment | 5 |
| Water | Solvent | Balance |

*Tergitol ™ TMN-6 is available from Dow Chemical Corporation, and Acticide ® B20 and Acticide ® M20 are available from THOR Specialties, Inc.

### Example 2—Effective Charge Stabilization of Various Ink Formulations

The effective charge stabilization of the various ink compositions were determined based on Formula I.

(Polymeric Dispersant Acid Number)×(Weight Ratio of the Polymeric Dispersant to Pigment)×(Total Pigment Load)=Effective Charge Stabilization Formula I

The pigment type, polymeric dispersant acid number, and ratio of the polymeric dispersant to pigment in the pigment dispersions varied as shown in Table 2 below.

TABLE 2
Ink Compositions with Effective Charge Stabilization Value

| | | | Pigment Dispersion | | | | |
|---|---|---|---|---|---|---|---|
| | | | Polymeric | | | Pigment Ink | |
| | | | Dispersant | Weight | | | Effective |
| | | | Acid | Ratio of | Relative | | Charge |
| | | | Number as | Polymeric | Charge | | Stabili- |
| Ink | Pigment | Pigment | measured | Dispersant | Stabili- | Pigment | zation of |
| ID | ID | Type | by KOH(A) | to Pigment | zation | Load | Ink |
| C1 | PB15:3 | Cyan A | 180 | 0.3 | 54 | 5 wt % | 2.70 |
| C2 | PB15:3 | Cyan A | 120 | 0.2 | 24 | 5 wt % | 1.20 |
| M1 | DIC-QA | Magenta A | 171 | 0.2 | 34 | 5 wt % | 1.71 |
| M2 | DIC-QA | Magenta A | 117 | 0.2 | 23 | 5 wt % | 1.17 |
| M3 | DIC-QA | Magenta A | 117 | 0.1 | 12 | 5 wt % | 0.59 |
| M4 | PR150 | Magenta B | 173 | 0.2 | 35 | 5 wt % | 1.73 |
| M5 | PR150 | Magenta B | 117 | 0.1 | 12 | 5 wt % | 0.59 |
| Y1 | PY74 | Yellow A | 180 | 0.3 | 54 | 5 wt % | 2.70 |
| Y2 | PY74 | Yellow A | 180 | 0.1 | 18 | 5 wt % | 0.90 |
| Y3 | PY74 | Yellow A | 117 | 0.1 | 12 | 5 wt % | 0.59 |

### Example 3—Impact of Effective Charge Stabilization on Color Saturation for Cyan, Magenta, and Yellow Inks

In order to determine the effect of the effective charge stabilization on color saturation the ink compositions above (C1-C2, M1-M5, and Y1-Y3) were printed on Hammermill® Great White 30% Recycled Media and on Staples® Copy Paper. The color saturation was determined using Greytag Macbeth Spectralino with a X-rite automated measurement using the CIE L*, a*, b*, C* h standards. The X-rite automated measurement was acquired using an X-rite EO2BAS I1Basic Pro 2 with EO2AST I1 IO Scanning Table set to 2° observer, ANSI settings, reflection, no filter, and D65.

TABLE 3
Color Saturation Level on Various Media

| | Pigment Ink | Saturation Level | |
|---|---|---|---|
| | Effective Charge | HMGW30 | SCP |
| Ink ID | Stabilization of Ink | Media* | Media* |
| C1 | 2.70 | 0.76 | 0.78 |
| C2 | 1.20 | 0.96 | 0.83 |
| M1 | 1.71 | 1.01 | 0.96 |
| M2 | 1.17 | 1.09 | 1.00 |
| M3 | 0.59 | 1.20 | 1.02 |
| M4 | 1.73 | 1.05 | 0.97 |
| M5 | 0.59 | 1.24 | 1.07 |
| Y1 | 2.70 | 0.83 | 0.85 |
| Y2 | 0.90 | 0.87 | 0.86 |
| Y3 | 0.59 | 0.89 | 0.86 |

*HMGW30 Media refers to Hammermill ® Great White 30% Recycled Media and SCP Media refers Staples ® Copy Paper.

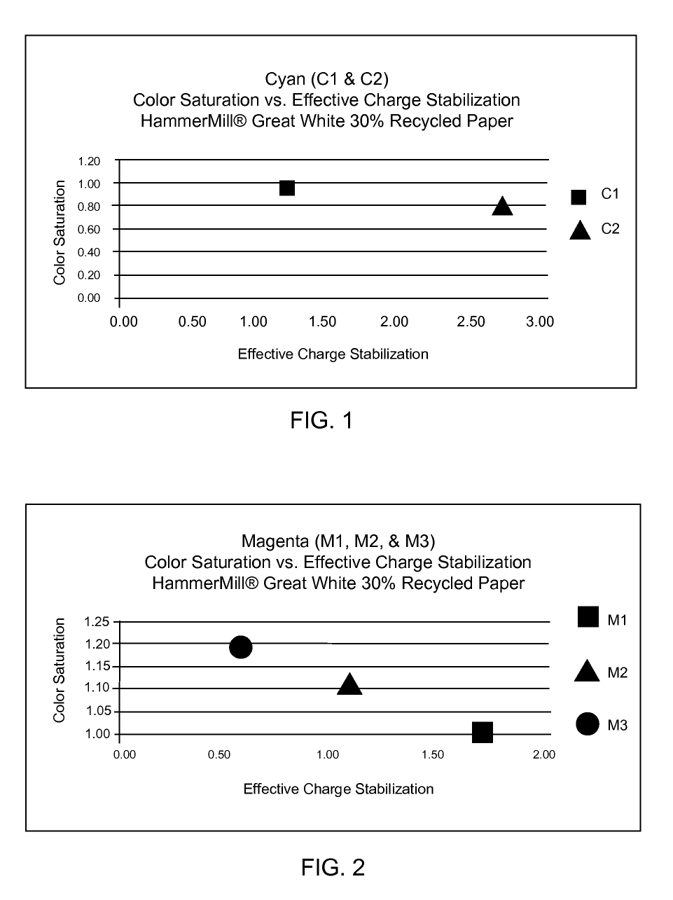

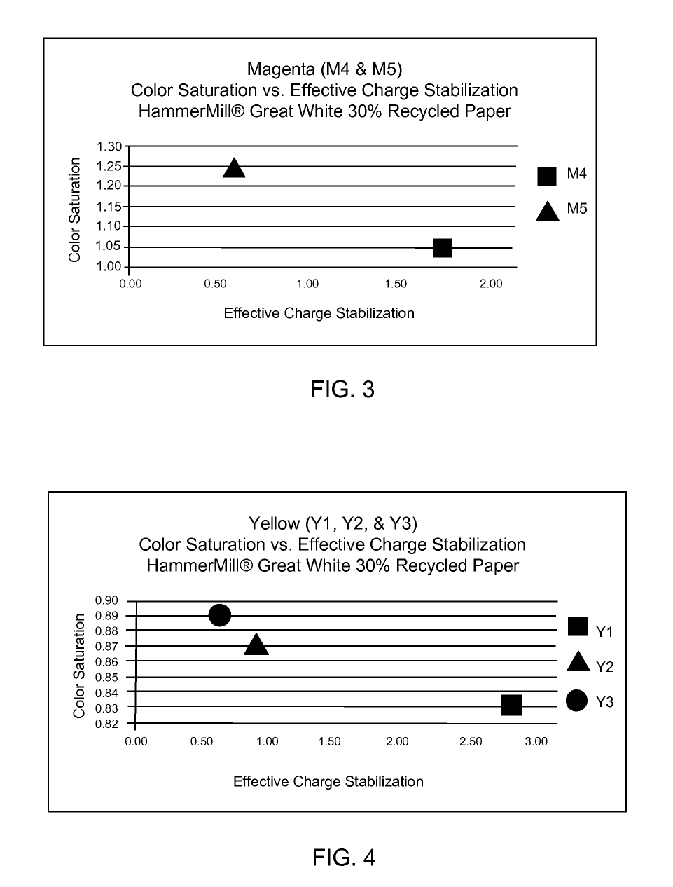

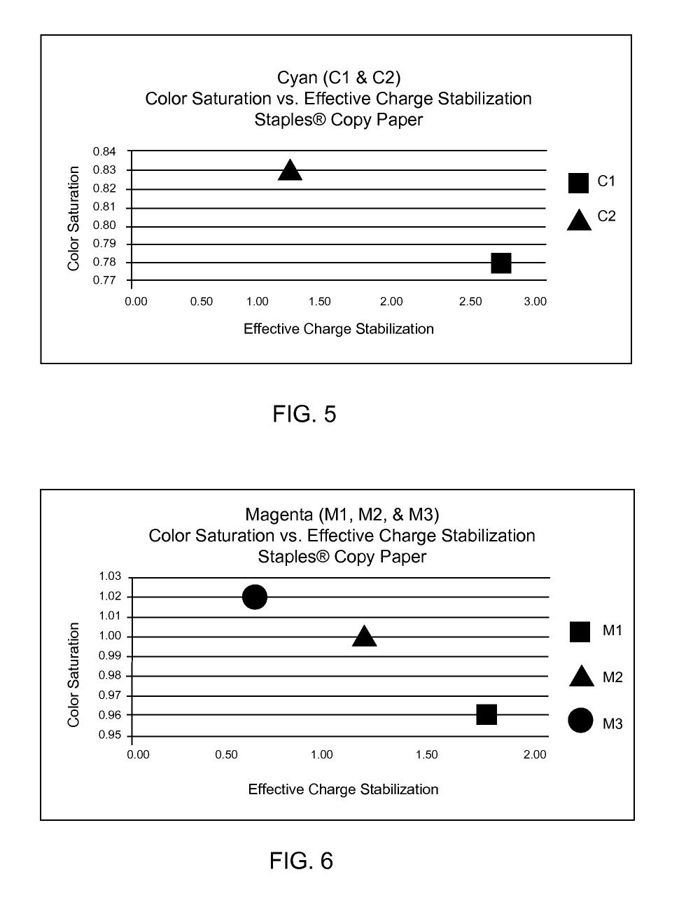

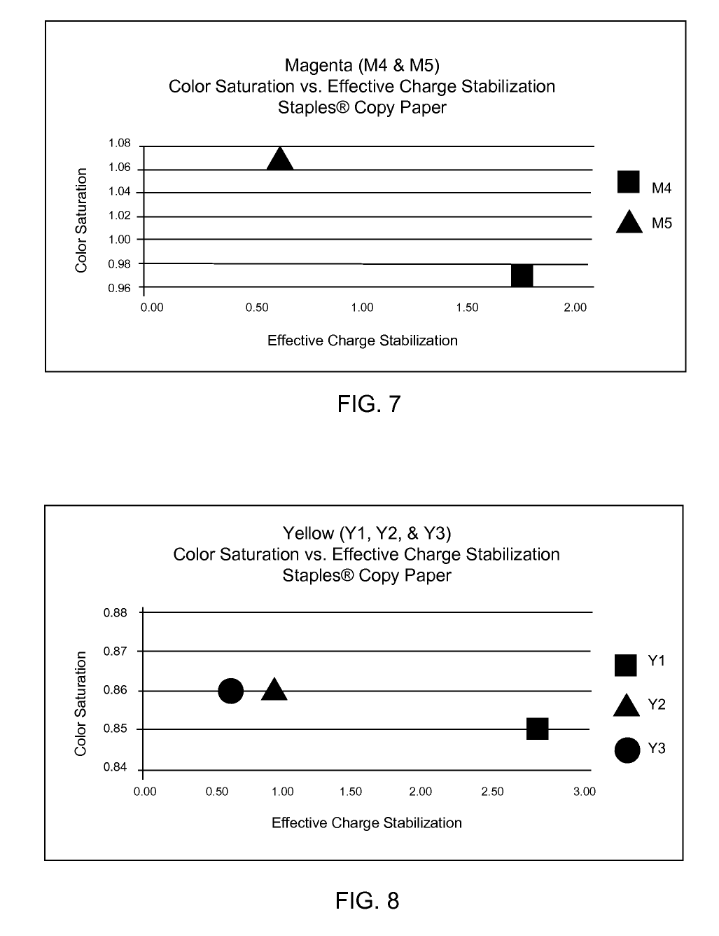

As shown in Table 3 above, in general, when the effective charge stabilization of the ink composition was decreased, the color saturation on the print media increased. FIGS. 1-8 hereinafter display the data shown in Table 3 related color saturation vs. effective charge stabilization for the various ink composition colors on two different types of plain print media. The figures are separated based on pigment and media.

### Example 4—Impact of Effective Charge Stabilization on Color Saturation in Ink Sets

The cyan, magenta and yellow ink sets were used to generate the red, green and blue colors. For example, to generate the red print, magenta and yellow inks were printed in varying amounts. The red saturation is reported for the color block printed using the magenta and yellow inks for which the hue angle was between 15° to 25°. Similarly green print was generated by printing varying amounts of cyan and yellow ink and blue print was generated by printing varying amounts of cyan and magenta inks. Green saturation was recorded for color block with hue angle of 145° to 155° and blue saturation was recorded for color block with hue angle of 255° to 265°. Red, green, and blue inks were prepared in accordance with Tables 1 and 2. In order to determine the impact of the effective charge stabilization on color saturation for the ink compositions, the red, green, and blue inks were printed on Hammermill® Great White 30% Recycled Media and on Staples® Copy Paper and evaluated for color saturation.

The color saturation was determined using the methods described in Example 3 above. The color saturation and effective charge stabilization values as printed on Hammermill® Great White 30% Recycled Media are shown in Table 4A. The color saturation and effective charge stabilization values as printed on Staples® Copy Paper are shown in Table 4B.

TABLE 4A
Color Saturation and Effective Charge Stabilization
Hammermill ® Great White 30% Recycled

| | | | Effective Charge | |
|---|---|---|---|---|
| | Saturation | | Stabilization | |
| | Control | Set A | Control | Set A |
| | INK ID's | | | |
| | C1, | C2, | C1, | C2, |
| Reference | (M1 + M4), | (M3 + M5), | (M1 + M4), | (M3 + M5), |
| Color | Y1 | Y3 | Y1 | Y3 |
| Cyan | 0.77 | 0.99 | 2.70 | 1.20 |
| Magenta | 0.94 | 1.22 | 1.72 | 0.59 |
| Yellow | 0.84 | 0.93 | 2.70 | 0.59 |
| Red | 0.73 | 1.02 | — | — |
| Green | 0.71 | 0.86 | — | — |
| Blue | 0.77 | 0.97 | — | — |

TABLE 4B
Color Saturation and Effective Charge Stabilization
Staples ® Copy Paper

| | | | Effective Charge | |
|---|---|---|---|---|
| | Saturation | | Stabilization | |
| | Control | Set A | Control | Set A |
| | INK ID's | | | |
| | C1, | C2, | C1, | C2, |
| Reference | (M1 + M4), | (M3 + M5), | (M1 + M4), | (M3 + M5), |
| Color | Y1 | Y3 | Y1 | Y3 |
| Cyan | 0.78 | 0.78 | 2.70 | 1.20 |
| Magenta | 0.89 | 0.95 | 1.72 | 0.59 |
| Yellow | 0.83 | 0.83 | 2.70 | 0.59 |
| Red | 0.72 | 0.82 | — | — |
| Green | 0.72 | 0.74 | — | — |
| Blue | 0.75 | 0.75 | — | — |

Note that in Tables 4A and 4B above, the Effective Charge Stabilization values are not provided for the Red (R), Green (G), and Blue (B) inks because these inks are each merely mixtures (at various ratios) two of the primary colors selected from Cyan (C), Magenta (M), and Yellow (Y). If RGB pigments were used to generate the color (rather than mixtures of primary CMY), the effective charge stabilization for these specific pigmented inks would be relevant for the pigmented inks per se. Because RGB inks are mixtures of multiple pigments, in this example, when the effective charge stabilization is reduced for the CMY pigments, the saturation of not only the CMY inks is increased, but also for mixtures thereof, e.g., the RGB inks. Thus, the saturation of the RGB inks is improved by virtue of the pigments (CMY) that are mixed to form the RGB inks.

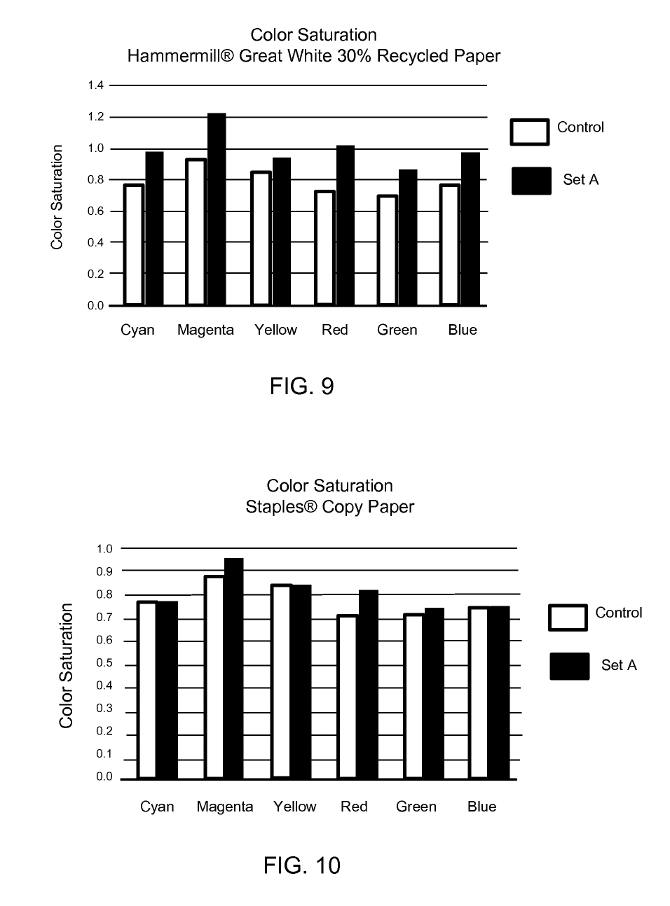

As shown in Tables 4A and 4B above, in general, when the effective charge stabilization of the ink set overall was decreased, the color saturation on the print media increased. FIG. 9 shows the Color Saturation for Control Inks that have a high effective charge stabilization (values >2 except for Magenta which is greater than >1.7) vs. the Color Saturation for inks having a low effective charge stabilization (values ≤1.5) as printed on Hammermill® Great White 30% Recycled Media. FIG. 10 shows the Color Saturation for Control Inks that have a high effective charge stabilization (values >2.40) vs. the Color Saturation for inks having a low effective charge stabilization (values ≤1.8) as printed on Staples® Copy Paper Media. As a note, the general trend held true for the RGB ink compositions when printed on both the Hammermill® Great White Recycled paper and Staples® Copy Media, with the exception of the Blue ink on the Staple® Copy Media where no change was noted.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An ink composition, comprising:
from 1 wt % to 8 wt % pigment load, and
a polymer dispersant associated with pigment, the polymer dispersant having hydrophilic moieties and hydrophobic moieties and an acid number from about 40 to about 180,
wherein the polymer dispersant to pigment weight ratio is less than 0.33, and wherein an effective charge stabilization of the ink composition is from about 0.3 to about 1.8 calculated based on a product of the acid number of the polymer dispersant, the polymer dispersant to pigment weight ratio, and the pigment load in the ink composition.

2. The ink composition of claim 1, wherein the polymer dispersant has a weight average molecular weight from about 2,000 Mw to about 20,000 Mw.

3. The ink composition of claim 1, wherein the polymer dispersant has a weight average molecular weight from about 5,000 Mw to about 12,000 Mw.

4. The ink composition of claim 1, wherein the polymer dispersant comprises polymerized monomers of styrene and an acrylic acid, or styrene and a methacrylic acid, or styrene and an acrylic acid and a methacrylic acid.

5. The ink composition of claim 1, wherein the pigment load is from about 2 wt % to 6 wt % of the ink composition.

6. The ink composition of claim 1, wherein the pigment is cyan and the effective charge stabilization of the ink is from about 0.6 to about 1.5.

7. The ink composition of claim 1, wherein the pigment is magenta and the effective charge stabilization of the ink is from about 0.3 to about 1.2

8. The ink composition of claim 1, wherein the pigment is yellow and the effective charge stabilization of the ink is from about 0.5 to about 1.

9. A method of making an ink composition, comprising:
dispersing a pigment with a polymer dispersant having hydrophilic moieties and hydrophobic moieties and an acid number from about 40 to about 180, wherein the polymer dispersant to pigment weight ratio is less than 0.33; and
admixing a liquid vehicle with the pigment and polymer dispersant to form the ink composition having a pigment load from 1 wt % to 8 wt %, wherein the ink composition has an effective charge stabilization from about 0.3 to about 1.5 calculated based on a product of the acid number of the polymer dispersant, the polymer dispersant to pigment weight ratio, and the pigment load in the ink.

10. The method of claim 9, wherein the pigment is cyan and the effective charge stabilization of the ink is from about 0.6 to about 1.5.

11. The method of claim 9, wherein the pigment is magenta and the effective charge stabilization of the ink is from about 0.3 to about 1.2

12. The method of claim 9, wherein the pigment is yellow and the effective charge stabilization of the ink is from about 0.5 to about 1.

13. The method of claim 9, wherein the polymer dispersant has a weight average molecular weight from about 2,000 Mw to about 20,000 Mw.

14. An ink set, comprising at least two ink compositions of:
a cyan ink, comprising:
from 1 wt % to 8 wt % cyan pigment load, and
a polymer dispersant associated with pigment and having hydrophilic moieties and hydrophobic moieties, wherein an acid number of the polymer dispersant is from about 40 to about 180, wherein a polymer dispersant to pigment weight ratio is less than 0.25, and wherein an effective charge stabilization of the cyan ink is from about 0.6 to about 1.5 calculated based on a product of the acid number of the polymer dispersant, the polymer dispersant to pigment weight ratio, and the cyan pigment load in the cyan ink composition;
a magenta ink, comprising;
from 1 wt % to 8 wt % magenta pigment load, and
a polymer dispersant associated with pigment and having hydrophilic moieties and hydrophobic moieties, wherein an acid number of the polymer dispersant is less than 150, wherein a polymer dispersant to pigment weight ratio is less than 0.25, and wherein an effective charge stabilization of the magenta ink is from about 0.3 to about 1.2 calculated based on a product of the acid number of the polymer dispersant, the polymer dispersant to pigment weight ratio, and the magenta pigment load in the magenta ink composition; and
a yellow ink, comprising:
from 1 wt % to 8 wt % yellow pigment load, and
a polymer dispersant associated with pigment and having hydrophilic moieties and hydrophobic moieties, wherein an acid number of the polymer dispersant is from about 40 to about 180, wherein a polymer dispersant to pigment weight ratio is less than 0.25, and wherein an effective charge stabilization of the yellow ink is from about 0.5 to about 1 calculated based on a product of the acid number of the polymer dispersant, the polymer dispersant to pigment weight ratio, and the yellow pigment load in the yellow ink composition.

15. The ink set of claim 14, wherein the ink set comprises at least three ink compositions including the cyan ink, the magenta ink, and the yellow ink.
